(19) United States
(12) Patent Application Publication
(10) Pub. No.: US 2013/0339121 A1
(43) Pub. Date: Dec. 19, 2013

(54) SYSTEM AND METHOD FOR AUTOMATED EVENT ENTRY AT TRANSACTION COMPLETION

(71) Applicant: Robert Bowden, Little Silver, NJ (US)

(72) Inventor: Robert Bowden, Little Silver, NJ (US)

(21) Appl. No.: 13/897,352

(22) Filed: May 17, 2013

Related U.S. Application Data
(60) Provisional application No. 61/660,022, filed on Jun. 15, 2012.

(51) Int. Cl. G06Q 30/02

(52) U.S. Cl. CPC G06Q 30/0224
USPC 705/14.25

(57) ABSTRACT

The present invention generally relates to the entry of events (e.g., donations, contests, rewards programs). Specifically, this invention relates to a system and method for providing automatic entry into an event at the completion of a transaction.

### CROSS-REFERENCE TO RELATED APPLICATIONS

This application claims the benefit of the following provisional application which is hereby incorporated by reference in its entirety. 61/660,022, filed Jun. 15, 2012, the entire disclosure of which is incorporated herein by reference.

### FIELD OF THE INVENTION

The present invention generally relates to the entry of events (e.g., donations, contests, rewards programs). Specifically, this invention relates to a system and method for providing automatic entry into an event at the completion of a transaction.

### BACKGROUND OF INVENTION

Merchants and companies of all types are constantly seeking ways to promote, grow, and foster goodwill in their business. There are many ways for these businesses to achieve these goals, but some of the primary ways those goals are accomplished are through rewards programs, contests, and partnerships with charitable organizations. One of the primary obstacles in accomplishing these goals, however, is getting customers and users enrolled into these programs. Specifically, many of these programs require that a consumer or user register themselves for these programs on their own, which is a time consuming step that many users might not take. When that is issue is factored together with those users who simply forget to enroll the programs, businesses are left with minimum and otherwise unsatisfying levels of enrollment that do not maximize the expected return. In general, currently available systems and methods require too much effort and time from customers and other users to register for the special programs and events offered by businesses.

Therefore, there is a need in the art for a system and method that streamlines the registration process by automatically registering a user at the end of a transaction with a business. These and other features and advantages of the present invention will be explained and will become obvious to one skilled in the art through the summary of the invention that follows.

### SUMMARY OF THE INVENTION

Accordingly, it is an aspect of present invention to provide a system and method for the automated entry of a user into a program or event offered by a business. In certain embodiments, the system and method may be used to register a user in a user rewards program. In alternate embodiments, the system and method may be used as a part of a partnership between a business and charitable organization for soliciting contributions to a charity.

According to an embodiment of the present invention, a system for automated event entry at transaction completion, the system comprising: an event entry module comprising computer-executable code stored in non-volatile memory, a processor, and a communications means, wherein the event entry module, the processor, and the communications means are operably connected and are configured to: confirm whether a customer is owed a balance amount on a payment transaction, generate an entry code for the customer, wherein the entry code is generated when the customer is owed the balance amount, provide the entry code to the customer, wherein the entry code is configured for entry on a customer computing device, receive a validation request from a merchant computing device, wherein the merchant computing device is provided an entry communication from the customer computing device, validate the an entry communication, wherein the event entry module validates the entry communication to the merchant computing device by verifying one or more of the payment transaction, the balance amount, the entry code, and a payment transaction date, and enter the customer into one or more events, wherein the one or more events is selected from a group of event types including a charitable donation, a contest, a customer discount, or a reward program, wherein the one or more events is designated via one or more entry types selected from the group of entry types including, random event selection, customer event selection, merchant event selection, or event section based on balance amount, wherein the balance amount is contributed towards the one or more events.

According to an embodiment of the present invention, the event entry module, the processor, and the communications means are further configured to collect the balance amount for the one or more events from one or more customers.

According to an embodiment of the present invention, the event entry module, the processor, and the communications means are further configured to distribute the balance amount collected for the one or more events to each of the one or more events.

According to an embodiment of the present invention, the entry code is selected from the group of entry codes including unique ID codes, barcodes, and QR codes.

According to an embodiment of the present invention, the balance amount is an amount of change due to the customer when the customer pays for the payment transaction with a change generating payment source.

According to an embodiment of the present invention, the balance amount is an amount added to the payment transaction when the customer pays for say payment transaction with a non-change generating payment source.

According to an embodiment of the present invention, the entry code is configured to be entered into the customer computing device when the customer scans the entry code with the customer computing device.

According to an embodiment of the present invention, the entry code is configured to be entered into the customer computing device when the customer computing devices receives the entry code from merchant computing device via a code communication means.

According to an embodiment of the present invention, the code communications means is one or more code communications means selected from the group of code communication means including near-field communication (NFC), radio-frequency identification (RFID), Bluetooth, and wireless communications.

According to an embodiment of the present invention, a method for automated event entry at transaction completion, the method comprising the steps of: confirming whether a customer is owed a balance amount on a payment transaction, generating an entry code for the customer, wherein the entry code is generated when the customer is owed the balance amount, providing the entry code to the customer, wherein the entry code is configured for entry on a customer computing device, receiving a validation request from a merchant computing device, wherein the merchant computing device is provided an entry communication from the customer computing device, validating the an entry communication, wherein the event entry module validates the entry communication to the merchant computing device by verifying one or more of the payment transaction, the balance amount, the entry code, and a payment transaction date, and entering the customer into one or more events, wherein the one or more events is selected from a group of event types including a charitable donation, a contest, a customer discount, or a reward program,wherein the one or more events is designated via one or more entry types selected from the group of entry types including, random event selection, customer event selection, merchant event selection, or event section based on balance amount,wherein the balance amount is contributed towards the one or more events.

According to an embodiment of the present invention, the method further comprises the step of collecting the balance amount for the one or more events from one or more customers.

According to an embodiment of the present invention, the method further comprises the step of distributing the balance amount collected for the one or more events to each of the one or more events.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a schematic of a system for automated event entry at transaction completion, in accordance with an embodiment of the present invention; and

FIG. 4 is a process flow of an exemplary method in accordance with embodiments of the present invention.

### DETAILED SPECIFICATION

The present invention generally relates to the entry of events (e.g., donations, contests, rewards programs). Specifically, this invention relates to a system and method for providing automatic entry into an event at the completion of a transaction (e.g., payment transaction, point-of-sale (POS) transaction).

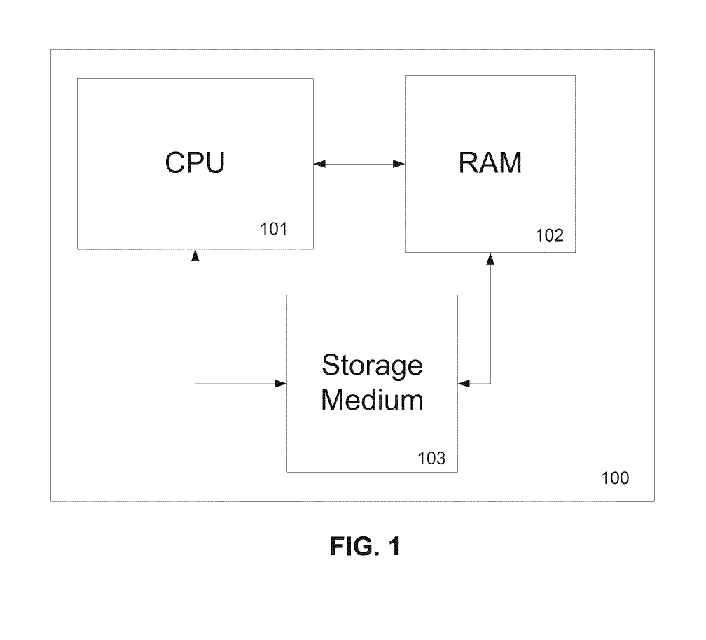

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

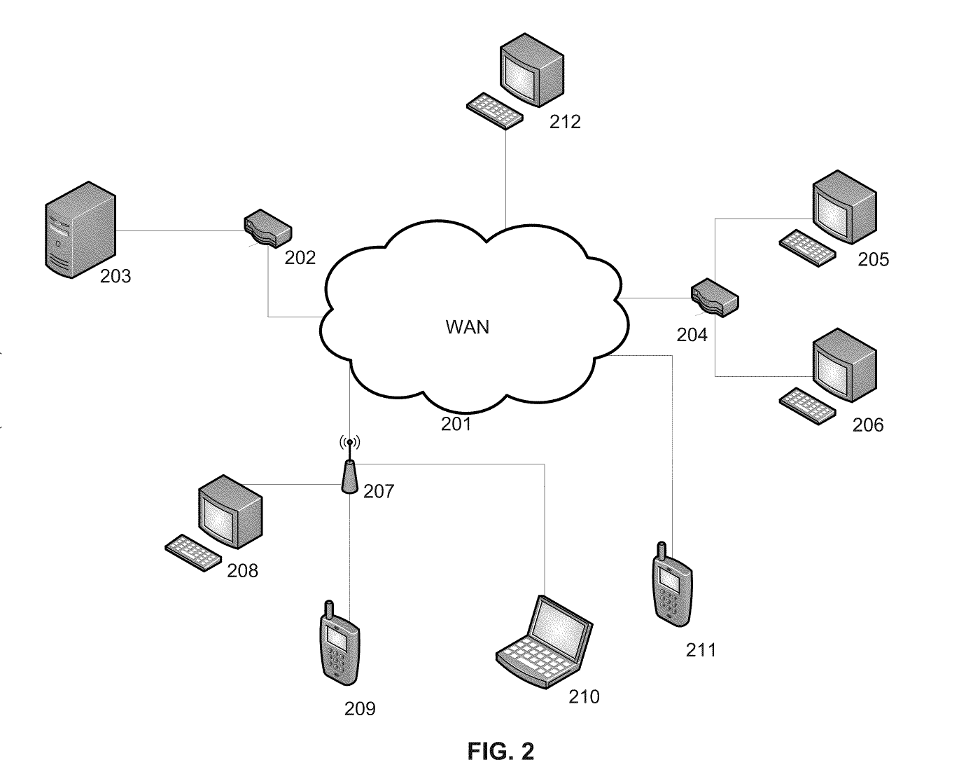

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

According to an embodiment of the present invention, the system provides the user the ability to interact with a computing device of a merchant in order to allow for the automatic entry into an event at the end of a payment transaction. In a preferred embodiment of the present invention, the user will be able to interact with the computing device of the merchant via a computing device operated by the user (e.g., user's smartphone).

Through use of the system, the merchant may allow the user to forfeit a portion of the change due to the user or select an amount of change/money to submit to the system in order to allow for automatic entry into an event. In a preferred embodiment of the present invention, the merchant may complete a payment transaction, such as a checkout for a purchase at a retail location, in which the user is due a balance. The merchant may then provide the user a code to enter or scan into the user's computing device in order to provide an entry into the desired event. Codes may include, but are not limited to, unique ID codes, barcodes and QR codes. One of ordinary skill in the art would appreciate that there are numerous types of codes that may be utilized with embodiments of the present invention, and embodiments of the present invention may be utilized with any type of code. Further, in certain embodiments, the codes may be provided to the computing device of the user via a communications means provided between the merchant's computing device(s) and the user's computing device. Communications means include, but are not limited to, near-field communication (NFC) means, RFID means, Bluetooth means and wireless communication means. One of ordinary skill in the art would appreciate that there are numerous communications means that may be utilized with embodiments of the present invention and embodiments of the present invention are contemplated for use with any type of communications means.

According to an embodiment of the present invention, once the user's computing device has received the code, the system may be configured to receive a communication from the user's computing device, identifying the transaction, the amount of change and the specific code provided by the merchant. The information is verified with communications received from the merchant and the merchant's computing devices. Once confirmed, the system uses the information to enter an event. The type of event and the type of entry may be pre-selected by the user, random or any combination thereof. The entrance type may be pre-selected by the user, random, based on the amount of change associated with the entry, or any combination thereof.

According to an embodiment of the present invention, event types may include a donation to a charity, either selected by the user, selected by the merchant, or any combination thereof, including systems where the user selects various charities they wish to donate to, and if one or more of those charities match charities identified by the merchant as acceptable charities for that merchant, the user may select one or more charities that match with the merchant for entry. In other embodiments of the present invention, the system may be configured to randomly select an event. Other event types include, but are not limited to, entry of the user into a contest (e.g., chance to win a gift certificate, chance to win a trip), entry of the user into a reward (e.g., 10% off your next purchase) or any combination thereof. One of ordinary skill in the art would appreciate that there are numerous types of entries that could be utilized with embodiments of the present invention and embodiments of the present invention are contemplated for use with any type of entry.

According to an embodiment of the present invention, types of entries may be preselected or preconfigured by the user, the merchant or any combination thereof. For instance, users may select desired entries that they wish to utilize. When a payment transaction is completed with a specific merchant, the user may be prompted as to what entries the merchant allows, especially those that match the preselected entries chosen by the user. Where there is no match between the user's desired entries and the merchant's allowable entries, the user may not be provided any entry selections or alternatively the user may be provided the option to select one or more entries allowable by the merchant.

In a preferred embodiment of the present invention, the system is configured to receive information from both the merchant and the user separately. Communication and receipt of information from both the merchant and the user may be required to confirm an entry transaction. In this manner, both the user and the merchant are required to enter in matching components (e.g., amount, code, time/day) in order to verify the entry transaction is a valid entry transaction.

According to an embodiment of the present invention, in events where a user is paying with a payment source that does not generate change (e.g., credit cards, debit cards), the system may be configured to allow the user to generate an entry as if they had utilized a payment source that provides change (e.g., cash, check, gift certificate, travelers checks). In order to accomplish this, the user may have a payment source registered with the system for use in these transactions. For example, if the user is completing a transaction for $9.54 and is using a credit card, the system may provide the user to pay as if the transaction value was $10.00 and have the remaining $0.46 utilized for generation of the entry. In this manner, the system may be utilized, even where the user is not utilizing a payment source that provides change.

According to an embodiment of the present invention, the merchant will retain the change or other balance of payments until such time as the system collects the balance. The system may be configured to automatically collect the balance from the merchant via one or more electronic means (e.g., ACH payments, wire transfer, bank transfer, credit card payments). In this manner, the payments for the entries may be batch processed allowing for less overhead during the normal operating hours of the merchant. Once receiving the payments, the system may be further configured to automatically distribute the payments to the various designated recipients (e.g., charitable organizations).

### Exemplary Embodiments

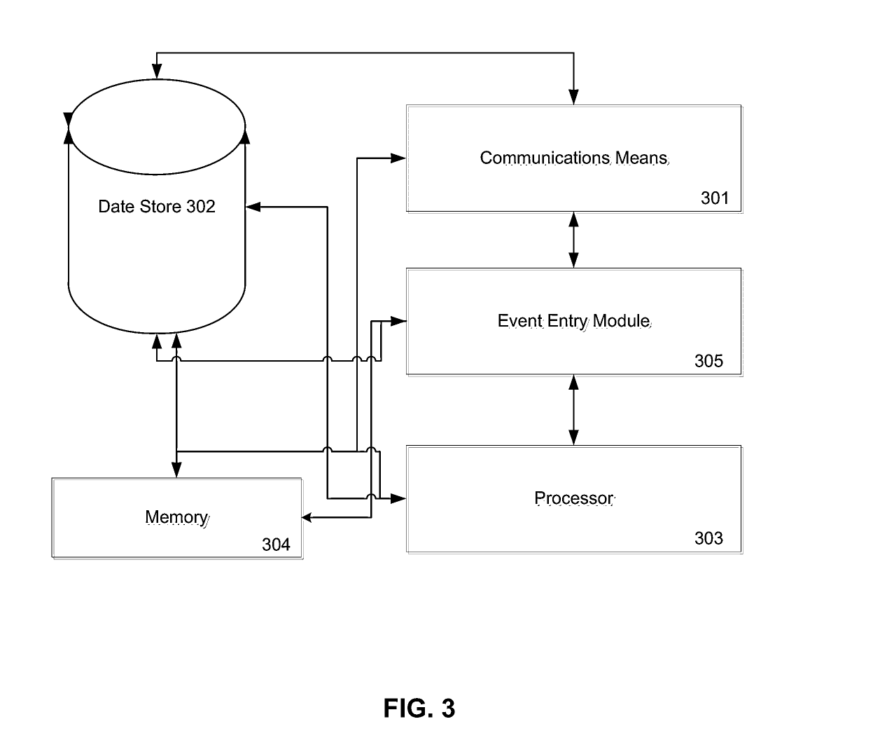

Turning now to FIG. 3, according to an embodiment of the present invention, the moving services bid generator and related methods herein described may be implemented through the use of one or more computing devices comprising a communications means 301, one or more data stores 302, a processor 303, a memory 304, and an event module 305 all communicatively connected. One or ordinary skill in the art would appreciate that there are numerous types of processors that could be utilized with embodiments of the present invention as well as numerous types of memory (e.g., Flash, RAM, ROM, cache, storage), and embodiments of the present invention are contemplated for use with any type of processor and memory.

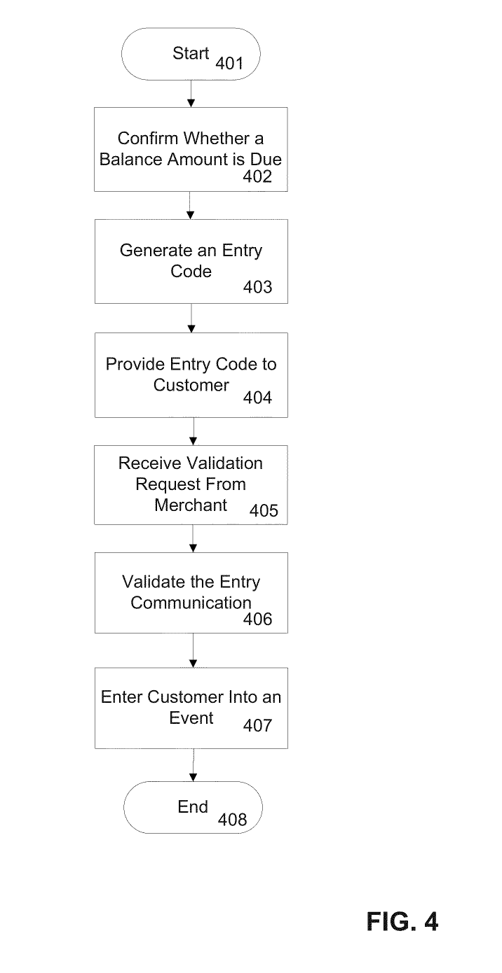

Turning now to FIG. 4, an exemplary process flow for a method for automated event entry at transaction completion is shown. The process starts at step 401, with a customer engaging in a transaction with a merchant.

At step 402, the event entry module confirms whether a balance amount is due to the customer on a payment transaction. In a preferred embodiment, the balance amount is any change due to a customer when the customer completes the transaction with a change generating payment source (For example, payment sources which include, but are not limited to, cash and checks.). In an alternate preferred embodiment, the balance amount is an amount added to the amount of the transaction when the customer completes the transaction with a non-change generating payment source (For example, payment sources which include, but are not limited to, credit cards and debit cards.).

At step 403, an entry code is generated. The entry code is used for the verification and entry of a customer into an event.

At step 404, the entry code is provided to the customer. The entry code can be scanned or entered by the customer into a computing device belonging to the customer. Alternatively, the entry can be provided by a merchant computing device to the customer computing device via a wireless communications means, including, but not limited to, Bluetooth, RFID, and near-field communication.

At step 405, the event entry module receives a validation request from the merchant computing device.

At step 406, the entry communication is validated by verifying one or more of the entry code, the payment transaction, the transaction date, and the transaction amount.

At step 407, the customer is entered into one or more events.

At step 408, the process terminates with the balance due being transferred as appropriate based on what event the customer was entered into.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for automated event entry at transaction completion, the system comprising:
an event entry module comprising computer-executable code stored in non-volatile memory,
a processor, and
a communications means,
wherein said event entry module, said processor, and said communications means are operably connected and are configured to:
confirm whether a customer is owed a balance amount on a payment transaction;
generate an entry code for said customer, wherein said entry code is generated when said customer is owed said balance amount;
provide said entry code to said customer, wherein said entry code is configured for entry on a customer computing device;
receive a validation request from a merchant computing device; wherein said merchant computing device is provided an entry communication from said customer computing device;
validate said an entry communication; wherein said event entry module validates said entry communication to said merchant computing device by verifying one or more of said payment transaction, said balance amount, said entry code, and a payment transaction date; and
enter said customer into one or more events, wherein said one or more events is selected from a group of event types comprising a charitable donation, a contest, a customer discount, or a reward program,
wherein said one or more events is designated via one or more entry types selected from the group of entry types comprising, random event selection, customer event selection, merchant event selection, or event section based on balance amount,
wherein said balance amount is contributed towards said one or more events.

2. The system of claim 1, wherein said event entry module, said processor, and said communications means are further configured to collect said balance amount for said one or more events from one or more customers.

3. The system of claim 2, wherein said event entry module, said processor, and said communications means are further configured to distribute said balance amount collected for said one or more events to each of said one or more events.

4. The system of claim 1, wherein said entry code is selected from the group of entry codes comprising unique ID codes, barcodes, and QR codes.

5. The system of claim 1, wherein said balance amount is an amount of change due to said customer when said customer pays for said payment transaction with a change generating payment source.

6. The system of claim 1, wherein said balance amount is an amount added to said payment transaction when said customer pays for say payment transaction with a non-change generating payment source.

7. The system of claim 1, wherein said entry code is configured to be entered into said customer computing device when said customer scans said entry code with said customer computing device.

8. The system of claim 1, wherein said entry code is configured to be entered into said customer computing device when said customer computing devices receives said entry code from merchant computing device via a code communication means.

9. The system of claim 8, wherein said code communications means is one or more code communications means selected from the group of code communication means comprising near-field communication (NFC), radio-frequency identification (RFID), Bluetooth, and wireless communications.

10. A method for automated event entry at transaction completion, the method comprising the steps of:
confirming whether a customer is owed a balance amount on a payment transaction;
generating an entry code for said customer, wherein said entry code is generated when said customer is owed said balance amount;
providing said entry code to said customer, wherein said entry code is configured for entry on a customer computing device;
receiving a validation request from a merchant computing device; wherein said merchant computing device is provided an entry communication from said customer computing device;
validating said an entry communication; wherein said event entry module validates said entry communication to said merchant computing device by verifying one or more of said payment transaction, said balance amount, said entry code, and a payment transaction date; and
entering said customer into one or more events, wherein said one or more events is selected from a group of event types comprising a charitable donation, a contest, a customer discount, or a reward program,
wherein said one or more events is designated via one or more entry types selected from the group of entry types comprising, random event selection, customer event selection, merchant event selection, or event section based on balance amount,
wherein said balance amount is contributed towards said one or more events.

11. The method of claim 10, further comprising the step of collecting said balance amount for said one or more events from one or more customers.

12. The system of claim 11, further comprising the step of distributing said balance amount collected for said one or more events to each of said one or more events.
